(19) United States
(12) Patent Application Publication
(10) Pub. No.: US 2014/0214563 A1
(43) Pub. Date: Jul. 31, 2014

(54) Product-Description-Improvement Apparatus And Method

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,163

(22) Filed: Jan. 31, 2013

(51) Int. Cl. G06Q 30/06

(52) U.S. Cl. CPC G06Q 30/0601
USPC 705/16

(57) ABSTRACT

A computer-implemented method is disclosed for obtaining improved product descriptions via crowd-sourcing. Within the method, a point-of-sale system forming part of a computer system may initiate a point-of-sale transaction involving a customer. The computer system may identify a first product description describing a first instance of a product being purchased as part of the point-of-sale transaction. The computer system may invite the customer to improve the first product description. In response to such an invitation, the computer system may receive, from a computing device corresponding to the customer, a second product description comprising an improved description of the first instance of the product. The second product description may then be stored by the computer system. The second product description may be vetted to ensure a certain level of quality. Subsequently, the second product description may be passed to other customers when they purchase other instances of the product.

### BACKGROUND

1. Field of the Invention

This invention relates to point-of-sale systems and more particularly to systems and methods for using customers to improve the product descriptions included within receipt data.

2. Background of the Invention

Many point-of-sale (POS) systems currently in use today do not support important emerging technologies, services, and marketing opportunities. For example, many POS systems are limited in their ability to collect, analyze, and use electronic receipt data. As a result, those POS systems cannot effectively implement many novel methods and services surrounding such data. Accordingly, what is needed is an apparatus and method expanding the ability of a wide variety of POS systems and supporting computer systems, include legacy POS systems, to collect, improve, and use electronic receipt data to benefit customers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram illustrating various types of product data in accordance with the present invention;

FIG. 2 is a schematic block diagram of one embodiment of a point-of-sale (POS) system for implementing methods in accordance with the present invention;

FIG. 3 is a schematic block diagram of one embodiment of multiple POS systems in accordance with the present invention operating in the context of an enterprise-wide system;

FIG. 4 is a schematic block diagram of one embodiment of a receipt in accordance with the present invention;

FIG. 5 is a schematic block diagram of one embodiment of a receipt module in accordance with the present invention;

FIG. 6 is a schematic block diagram of one embodiment of a description-improvement module in accordance with the present invention;

FIG. 7 is a schematic diagram of one embodiment of an itemized view of a receipt that may be provided, populated, or supported by a computer system (or a mobile application thereof) in accordance with the present invention; and

FIG. 8 is a block diagram of one embodiment of a method for improving product descriptions in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

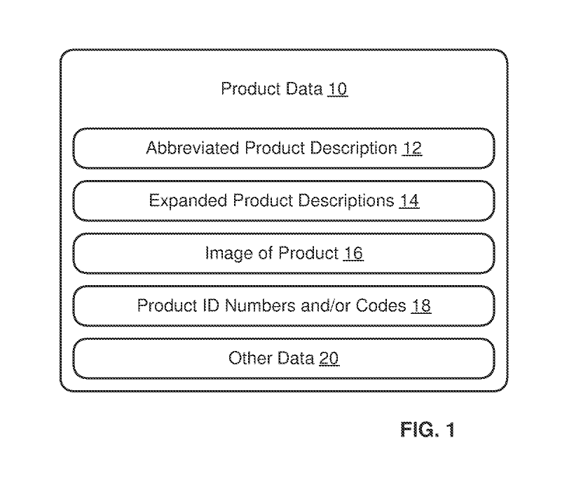

Referring to FIG. 1, business entities (e.g., retailers) may create, collect, store, process, and/or communicate product data 10. Product data 10 may enable a business entity to identify one or more products, describe one or more products, tract one or more products, track inventory, generate receipt data, or the like or a combination or sub-combination thereof. Product data 10 may come in various forms. For example, product data 10 may include one or more abbreviated product descriptions 12, expanded product descriptions 14, product images 16, product identification numbers and/or codes 18, other data 20, or the like or a combination or sub-combination thereof.

An abbreviated product description 12 may be a relatively short character string that describes the product corresponding thereto. An abbreviated product description 12 may be quite limited in the amount of information or detail it can provide. For example, “gum” may be the abbreviated product description 12 corresponding to one or more chewing gum products. Noticeably absent from such an abbreviated product description 12 may be the brand, flavor, quantity, or the like associated with the product. In selected embodiments or systems, an abbreviated product description 12 may comprise thirteen or fewer characters.

An expanded product description 14 may be a relatively long character string that describes the product corresponding thereto. An expanded product description 14 may provide significantly more information or detail than a corresponding abbreviated product description 12. For example, a particular chewing gum product may have “gum” as an abbreviated description 12 and “ORBIT Spearmint Sugarfee Gum, 6 pc” as an expanded product description 14. In selected embodiments or systems, an abbreviated product description 12 may comprise 255 or fewer characters.

A product image 16 may comprise a photograph, illustration, or the like showing a corresponding product or the packaging thereof. Thus, in certain embodiments, some portion of product data 10 may be passed, communicated, displayed, or the like as an image, not as text. For example, a product image 16 may be passed to a computing device of an appropriate customer in a stream including a raster-coded image or bitmap.

In selected embodiments, one or more product identification numbers and/or codes 18 may uniquely identify one or more products. For example, certain product identification numbers and/or codes 18 may correspond to or match the numbers coded within one or more Universal Product Codes (UPCs). Alternatively, or in addition thereto, certain product identification numbers and/or codes 18 may correspond to or provide one more Stock-Keeping Units (SKUs).

For customers viewing a receipt documenting a purchase, return, or the like, certain types of product data 10 may be more helpful than others. For example, product identification numbers and/or codes 18 that may be very useful to a retailer's computer system may be substantially useless (e.g., uninterpretable) to the majority of customers. Expanded product descriptions 14 and product images 16, on the other hand, may be easily interpreted by customers. Unfortunately, expanded product descriptions 14 and product images 16 may not always be available or of sufficient quality. Accordingly, selected embodiments and systems in accordance with the present invention may improve the expanded product descriptions 14, product images 16, or the like that may be included within receipt data delivered to customers.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

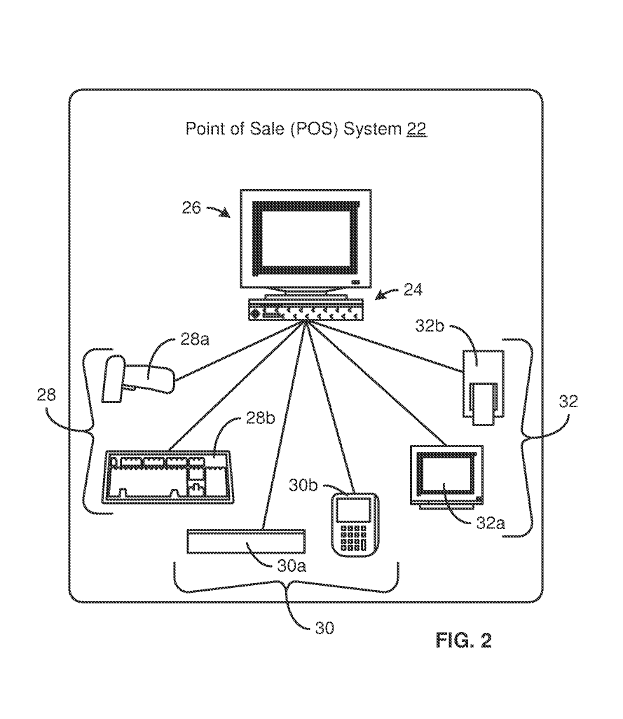

Referring to FIG. 2, in selected embodiments, the hardware, software, or hardware and software of a POS system 22 may be configured to implement or support one or more methods in accordance with the present invention. A POS system 22 in accordance with the present invention may include various components. In certain embodiments, a POS system 22 may include a central or primary computer 24, a monitor 26 (e.g., a cashier-facing monitor 26), one or more input devices 28 (e.g., scanners 28a, keyboards 28b, scales, or the like), one or more payment devices 30 (e.g., cash drawers 30a, card readers 30b) for receiving or returning payments, one or more output devices 32 (e.g., customer-facing display 32a or monitor 32a, receipt printer 32b), or the like or combinations or sub-combinations thereof.

A computer 24 may form the primary processing unit of a POS system 22. Other components 28, 30, 32 forming part of a POS system 22 may communicate with the computer 24. Input devices 28 and certain payment devices 30 may feed data and commands to a computer 24 for processing or implementation. For example, a scanner 28a may pass data communicating the identity of one or more items to be purchased, returned, or the like to a computer 24. Similarly, a card reader 30b may pass payment information to a computer 24.

Conversely, output devices 32 and certain payment devices 30 may follow or implement commands issued by a computer 24. For example, a cash drawer 30a may open in accordance with the commands of a computer 24. Similarly, a customer-facing display 32a and receipt printer 32b may display or output data or information as instructed by a computer 24.

In selected embodiments, in addition to handling consumer transactions (e.g., purchases, returns), a POS system 22 may also provide or support certain “back office” functionality. For example, a POS system 22 may provide or support inventory control, purchasing, receiving and transferring products, or the like. A POS system 22 may also store sales and customer information for reporting purposes, marketing purposes, receivables management, trend analysis, cost analysis, price analysis, profit analysis, or the like. If desired or necessary, a POS system 22 in accordance with the present invention may include an accounting interface to pass certain information to one or more in-house or independent accounting applications.

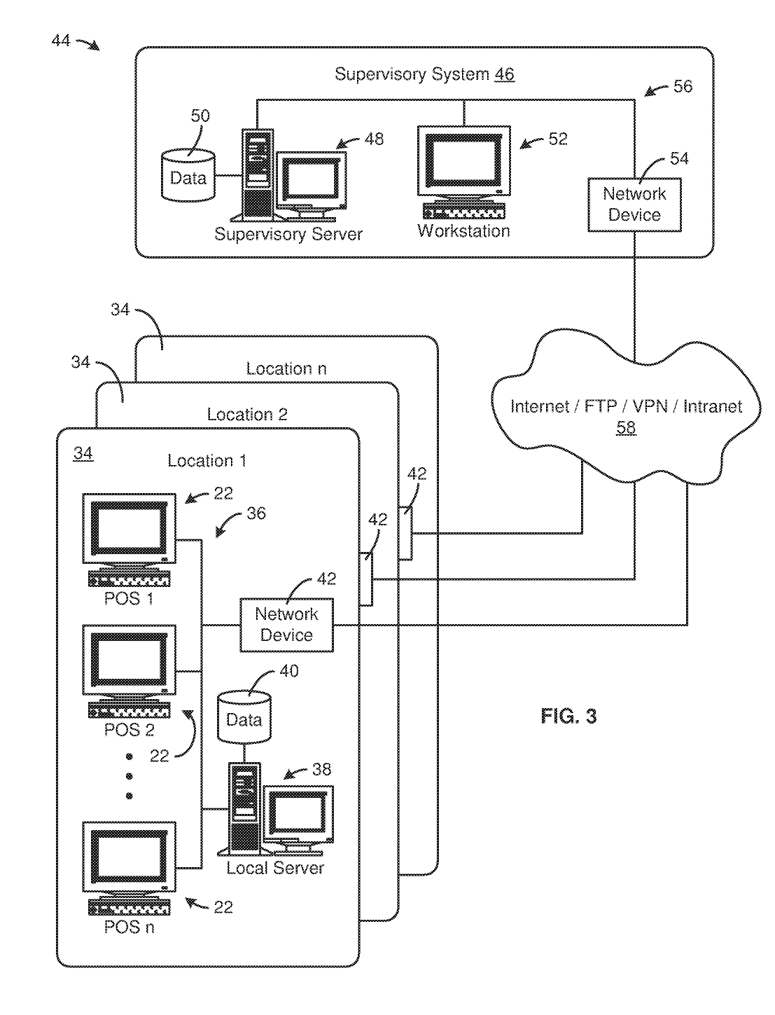

Referring to FIG. 3, in selected embodiments, a POS system 22 may operate substantially independently, as a stand-alone unit. Alternately, a POS system 22 in accordance with the present invention may be one of several POS systems 22 forming the front line of a larger system. For example, multiple POS systems 22 may operate at a particular location 34 (e.g., within a retail, brick-and-mortar store). In such embodiments, the various POS systems 22 may be interconnected via a LAN 36. A LAN 36 may also connect the POS systems 22 to a local server 38.

A local server 38 may support the operation of the associated POS systems 22. For example, a server 38 may provide a central repository from which certain data needed by the associated POS systems 22 may be stored, indexed, accessed, or the like. A server 38 may serve certain software to one or more POS systems 22. In certain embodiments, a POS system 22 may offload certain tasks, computations, verifications, or the like to a server 38.

Alternatively, or in addition thereto, a server 38 may support certain back office functionality. For example, a server 38 may receive and compile (e.g., within one or more associated databases 40) data from the various associated POS systems 22 to provide or support inventory control, purchasing, receiving and transferring products, or the like. A server 38 may also receive and compile sales and customer information for reporting purposes, marketing purposes, receivables management, trend analysis, cost analysis, price analysis, profit analysis, or the like.

In certain embodiments, one or more POS systems 22 or servers 38 corresponding to a particular location 34 may communicate with or access one or more remote computers or resources via one or more network devices 42. For example, a network device 42 may enable a POS system 22 to contact outside resources and verify the payment credentials (e.g., credit card information) provided by a customer. A network device 42 may comprise a modem, router, or the like.

In selected embodiments, a POS system 22 in accordance with the present invention may operate within an enterprise-wide system 44 comprising multiple locations 34 (e.g., branches 34 or stores 34). In such embodiments, each location 34 may have one or more POS systems 22, local servers 38, local databases 40, network devices 42, or the like or combinations or sub-combinations thereof connected by a computer network (e.g., a LAN 36). Additionally, each such location 34 may be configured to interact with one or more supervisory systems 46. For example, multiple branch locations 34 may report to an associated “headquarters” location or system.

A supervisory system 46 may comprise one or more supervisory servers 48, databases 50, workstations 52, network devices 54, or the like or combinations or sub-combinations thereof. The various components of a supervisory system 46 may be interconnected via a computer network (e.g., a LAN 56). In selected embodiments, a supervisory system 46 may comprise one or more supervisory servers 48 providing a central repository from which certain data needed by the one or more POS systems 22 or local servers 38 may be stored, indexed, accessed, or the like.

Alternatively, or in addition thereto, a supervisory server 48 may receive and compile (e.g., within one or more associated databases 50) data from the various associated POS systems 22 or local servers 38 to provide or support inventory control, purchasing, receiving and transferring products, or the like. A supervisory server 48 may also receive and compile sales and customer information for reporting purposes, marketing purposes, receivables management, trend analysis, cost analysis, price analysis, profit analysis, or the like.

A supervisory system 46 may be connected to one or more associated locations 34 or branches 34 in via any suitable computer network 58 (e.g., WAN 58). For example, in selected embodiments, one or more locations 34 may connect to a supervisor system 46 via the Internet. Communication over such a network 58 may follow any suitable protocol or security scheme. For example, communication may utilize the File Transfer Protocol (FTP), a virtual private network (VPN), intranet, or the like.

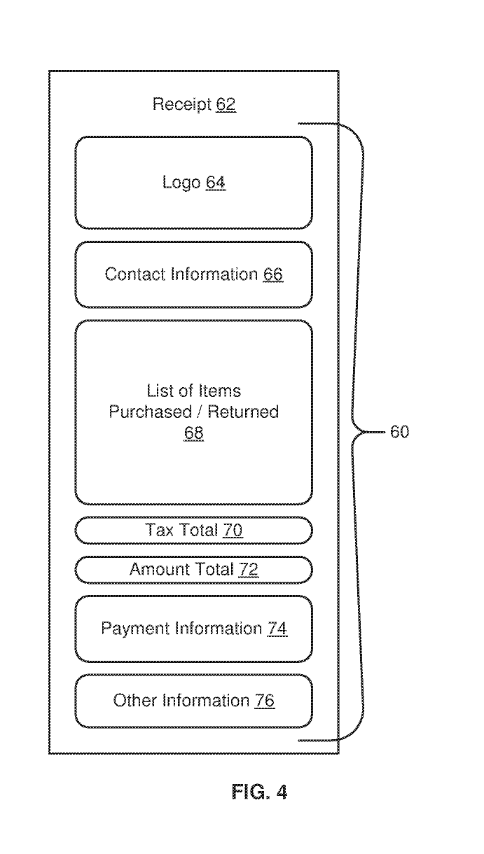

Referring to FIG. 4, a POS system 22 may collect and/or generate receipt data 60. Receipt data 60 may document a transaction (e.g., sale or return) carried out by a POS system 22. Receipt data 60 may be presented or displayed to a customer in the form of receipt 62 (e.g., a hardcopy receipt, “paperless” electronic receipt, or the like or a combination thereof). In selected embodiments, receipt data 60 may be delivered electronically to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 22, local servers 38, supervisory servers 48, some other onsite resources, one or more applications running on a customer's computing device, some other offsite resources, or the like or combinations or sub-combinations thereof, hereinafter a “computer system”).

In selected embodiments, receipt data 60 and a receipt 62 may include a logo 64, contact information 66, a list 68 of items purchased or returned, a total 70 indicating the sales tax assessed or returned, a total 72 indicating the amount paid or returned, payment information 74, other information 76, or the like or combinations or sub-combinations thereof.

A logo 64 may reinforce the brand and image of the associated entity within the mind of a consumer. By including contact information 66 on a receipt 62, an entity may ensure that a customer has ready access to one or more physical addresses, Internet address, telephone numbers, facsimile numbers, hours of operation, or the like or combinations or sub-combinations thereof. One or more of a list 68 of items purchased or returned, a total 70 indicating the sales tax assessed or returned, a total 72 indicating the amount paid or returned, and payment information 74 (e.g., date of transaction, an indication of method of payment, an indication of which credit or debit card was used, etc.) may be included to document important details of a transaction. In selected embodiments, a list 68 of items purchased may include certain product data 10.

Other information 76 may be included within a receipt 62 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

In selected embodiments, other information 76 contained within receipt data 60 may include information (e.g., meta data or the like) that is not directly displayed to a customer (or not displayed in certain views or settings). In certain embodiments, such information may comprise product data 10. For example, receipt data 60 may include one or more expanded product descriptions 14, product images 16, or the like.

A receipt 62 passed to a computing device of a customer in electronic format may be presented by the computing device in any suitable layout or format. For example, the receipt data 60 forming a receipt 62 may simply be presented as a textual list. Alternatively, an electronic version of the receipt 62 may follow the form of a paper receipt. That is, a receipt 62 in an electronic format may comprise a virtual representation or layout substantially matching what a comparable paper receipt would look like.

The manner in which a receipt 62 in an electronic format is presented or displayed on a computing device of a customer may be completely dictated by the computer system delivering the receipt data 60 thereto. Alternatively, the computing device of the customer may have an application (e.g., a receipt manager, accounting program, budgeting program, browser, or the like) installed thereon. Such an application may partially or completely control the layout or format of receipt data 60 displayed therewith or therethrough. For example, a computer system may supply receipt data 60, while the application installed on the computing device of the customer supplies the layout or formatting.

In selected embodiments, the manner in which receipt data 60 is displayed to a customer (or the options made available to a customer with respect to the receipt data 60) may be based at least in part on the particular view selected by the customer. For example, in certain embodiments, a primary or basic view or setting may correspond to a receipt 62 presented as a virtual representation or layout substantially matching what a comparable paper receipt would look like. In such embodiments, a secondary or itemized view or setting may correspond to richer product data 10.

For example, while a primary or basic view may include abbreviated product descriptions 12, a secondary or itemized view may include expanded product descriptions 14, product images 16, or the like or a combination thereof. Accordingly, if a customer is unable to identify a product by its abbreviated product description 12, the customer may switch to an itemized view to obtain or view more detailed information. In selected embodiments, this more detailed information may facilitate one or more searches of the receipt data 60. For example, expanded product descriptions 14 may enable a customer to search one or more receipts 62 or corresponding receipt data 60 using normal language and/or words rather than particular abbreviations that may be obscure, unfamiliar, or unknown.

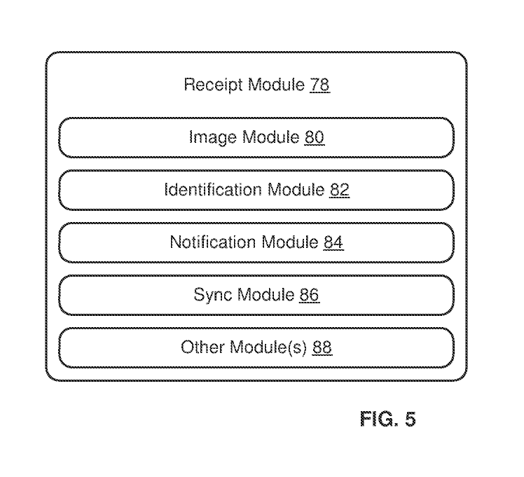

Referring to FIG. 5, a computer system in accordance with the present invention may deliver receipt data 60 to a printer 32b, computing device of a customer, or the like in any suitable manner. In selected embodiments, a receipt module 78 may enable or support such delivery. A receipt module 78 may include any suitable arrangement of sub-components or modules. In certain embodiments, a receipt module 78 may include an image module 80, identification module 82, notification module 84, synchronization module 86, one or more other modules 88 as desired or necessary, or the like or some combination or sub-combination thereof.

An image module 80 may assemble, generate, or obtain an advertisement comprising a call to action. A call to action may invite or motivate a customer to take a particular step or action. For example, a call to action may invite or motive a consumer to download receipt data 60. Alternatively, a call to action may invite or motive a customer to obtain an electronic receipt application, participate in an electronic receipt program, or the like.

To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 60 encoded within the code. Alternatively, scanning the code may initiate the download of receipt data 60, the download of an application for receiving and/or displaying receipt data 60, enrollment in an electronic receipt program, or the like or a combination or sub-combination thereof.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 82 may be tasked with requesting, collecting, and/or communicating identification information linking a customer associated with a transaction with one or more records stored within a computer system. For example, as part of a transaction carried out at a POS system 22, an identification module 82 may request, collect, and/or communicate identification information linking a transaction to a particular computing device or account corresponding to the customer participating in the transaction. Thus, information corresponding to the transaction may be passed to the customer via the particular computing device or account.

An identification module 82 may request, collect, and/or communicate one or more types of identification information. For example, in selected embodiments, an identification module 82 may collect a unique identification or membership number from a customer. This may be done when a membership card, club card, loyalty card, identification card, credit card, debit card, fingerprint or other biometric characteristic, or the like is scanned, input, or otherwise collected at a POS system 22. In other situations, a cashier or customer may type in a unique identification number, payment number, membership number, or the like at a POS system 22. For example, while a cashier is processing a transaction, a customer may be prompted via a card reader 30b, customer-facing display 32a, or the like to enter (e.g., type in using the card reader 30b) a mobile telephone number corresponding to the customer. Alternatively, a cashier may type in a telephone number corresponding to the customer.

Once the identification information is received, it may be used directly (e.g., used directly to pass receipt data 60 to a computing device of a corresponding customer). Alternatively, or in addition thereto, the identification information may tie or link a current transaction to one or more previously stored computer records. For example, within such records, a computer system may find the information necessary to identify and communicate with a computing device or account of a corresponding customer. Alternatively, or in addition thereto, such records may enable a computer system to tie or link a current transaction to an appropriate computing device or account.

A notification module 84 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 62 is available for download).

A synchronization module 86 may support or enable one way or two way data communication between a computer system and a computing device. For example, a synchronization module 86 may support or enable the passing of receipt data 60 or updated receipt data 60 from a computer system to a computing device. A synchronization module 86 may also enable certain data received from a computing device to be incorporated within or used by a computer system. For example, one or more user preferences (e.g., notification preferences) may be communicated to a computer system from an application resident on a computing device.

The various functions or modules of a receipt module 78 may be enacted or implemented by any suitable system or component thereof. For example, in selected embodiments, one or more functions or modules of a receipt module 78 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

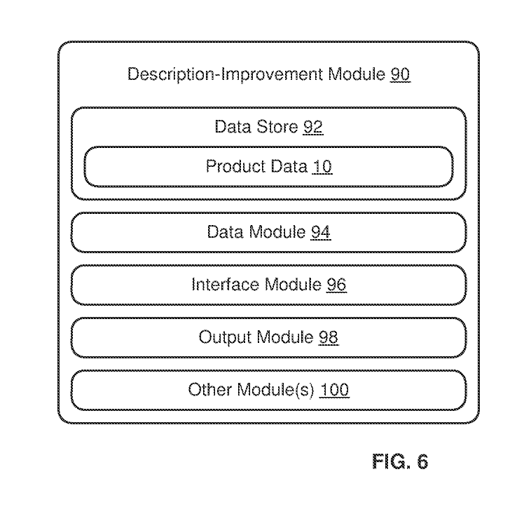

Referring to FIG. 6, in selected embodiments, one or more computers, computers systems, mobile computing devices, or the like or a combination or sub-combination thereof may support or enable a description-improvement module 90. A description-improvement module 90 may empower one or more customers to improve certain product data 10. A description-improvement module 90 may include any suitable arrangement of sub-components or modules. In certain embodiments, a description-improvement module 90 may include a data store 92, data module 94, interface module 96, output module 98, one or more other modules 100 as desired or necessary, or the like or a combination or sub-combination thereof.

A data store 92 may contain records supporting the operation of a description-improvement module 90. In selected embodiments, a data store 92 may contain or store product data 10. For example, a data store 92 may contain one or more abbreviated product descriptions 12, expanded product descriptions 14, product images 16, product identification numbers and/or codes 18, other data 20, or the like or a combination or sub-combination thereof.

In selected embodiments or situations, the product data 10 contained within a data store 92 may be incomplete. For example, product data 10 may not include a product image 16 for one or more products offered by a corresponding retailer. Similarly, product data 10 may not include an expanded product description 14 for one or more products offered by a corresponding retailer. Alternatively, or in addition thereto, certain pieces of product data 10 may be inaccurate or of low quality (e.g., low informational content). For example, one or more expanded product descriptions 14 may not include important information (e.g., brand, size, weight, variety, or the like) about a corresponding product.

A data store 92 may contain product data 10 applicable to (e.g., used in conjunction with) different people. For example, a data store 92 may contain improved or customized product data 10 entered by a particular customer and used only in conjunction with the particular customer. Alternatively, or in addition thereto, a data store 92 may contain product data 10 of more wide-spread applicability. For example, certain product data 10 contained within a data store 92 may be applicable to or used in conjunction with all customers or customers of a particular demographic, geographic region, or the like.

A data store 92 may contain product data 10 in various stages of development. For example, at one extreme, a data store 92 may contain certain product data 10 that has been accepted and/or approved for use or dissemination (e.g., general, wide-spread, or individualized use or dissemination). At an opposite extreme, a data store 92 may contain certain product data 10 that is raw and unprocessed (e.g., product data 10 that has been received from one or more customers, but that has not yet been screened, filtered, quality tested, approved, used, or the like). A data store 92 may contain certain product data 10 that is in process (e.g., product data 10 that has been received from one or more customers and is in the process of being screened, filtered, quality tested, approved, used on a limited basis, or the like).

A data module 94 may perform certain processing or preprocessing functions with respect to selected contents of a data store 92. For example, in selected embodiments, a data module 94 may receive, collect, generate, format, communicate, and/or manage product data 10. For example, a data module 94 may receive (e.g., from an interface module 96) certain improved product data 10 generated by one or more customers and store the same within a data store 92.

A data module 94 may provide a mechanism through with selected product data 10 is vetted. For example, a data module 94 may assist in screening, filtering, quality testing, and/or approving certain product data 10. In vetting such product data 10, a data module 94 may operate automatically, as directed by one or more human users or controllers, or the like or some combination thereof. For example, in selected embodiments, a data module 94 may operate automatically or as directed by one or more human users to filter certain text-based product data 10 received from one or more customers to remove potentially offensive words or phrases, misspellings, grammatical errors, undesired or erroneous punctuation, or the like.

In certain embodiments, one or more customers may assist in a vetting process. For example, a data module 94 may present to select customers product data 10 received from one or more others customers. The data module 94 may inquire with the select customers as to whether the product data 10 is of sufficient quality. Alternatively, or in addition thereto, the data module 94 may monitor the interaction of the select customers with the product data 10. Accordingly, a data module 94 may collect feedback indicative of the quality of the product data 10.

A data module 94 may compare certain pieces of product data 10 against one or more other pieces of product data 10. In selected embodiments, this comparison may assist in assessing the quality of one or more of the pieces of product data 10 being compared. For example, one or more comparisons made by a data module 94 may reveal that multiple customers in diverse locations all submitted identical or very similar improved descriptions of a particular product. A data module 94 or one or more human users associated therewith may interpret such overlap as an indicator that one such improved description (e.g., the most repeated description among the identical or very similar improved descriptions) is accurate and helpful to customers. Accordingly, the improved description may be viewed as being a quality description (e.g., a quality expanded product description 14) that may be used generally or with a particular customer group.

In selected embodiments, a data module 94 may support vetting of non-textual product data 10. For example, a data module 94 may vet or assist in vetting one or more product images 16 received from one or more customers. This may be done in any suitable manner. For example, in certain embodiments, a data module 94 may provide a mechanism through which one or more product images 16 are viewed by one or more human reviewers. A data module 94 may also provide a mechanism through which such images 16 are graded (e.g., pass/fail, one through ten, or the like) by human reviewers. Accordingly, should some specified number (e.g., 1, 2, 3, or the like) of reviewers grade a product image 16 above some threshold (e.g., pass, five out of ten, or the like), the image 16 may be viewed as being a quality product image 16 that may be used generally or with a particular customer group.

In certain embodiments, a data module 94 may support editing of product data 10. For example, a data module 94 may edit one or more product images 16 received from one or more customers. Such editing may accomplish any suitable purpose. For example, a data module 94 (or a human user working through a data module 94) may change a format, resolution, or size of a product image 16, white out all background surrounding a product in a product image 16, or the like or combination or sub-combination thereof.

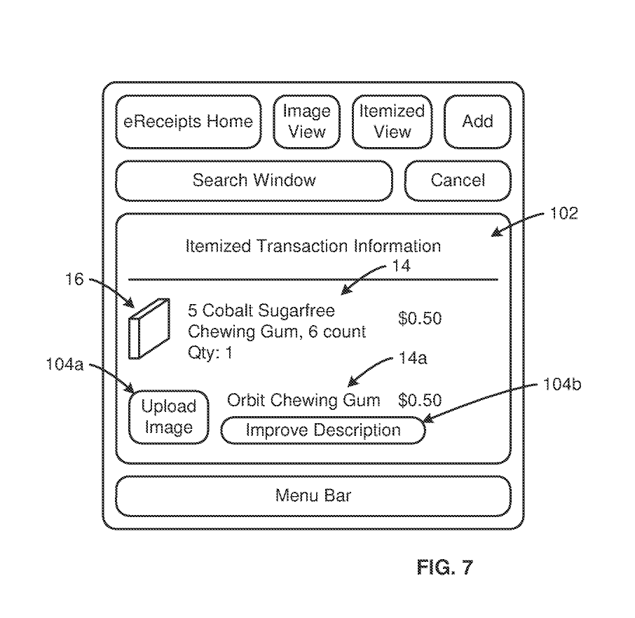

Referring to FIGS. 6 and 7, an interface module 96 may support interaction between a description-improvement module 90, one or more components of a description-improvement module 90, one or more components of a receipt module 78, or the like and one or more customers, computing devices corresponding to customers, accounts corresponding to customers, or the like. In selected embodiments, an interface module 96 may invite one or more customers to improve one or more pieces of product data 10.

For example, a receipt module 78 may deliver receipt data 60 to a customer. Certain product data 10 contained within such receipt data 60 may be incomplete or of low quality. For example, as illustrated, receipt data 60 (e.g., the receipt data 60 presented in an “itemized” view 102 or the like) may not include a product image 10, complete or quality expanded product description 14, or the like or a combination thereof for one or more products purchased by the customer. Accordingly, an interface module 96 may invite the customer to submit a product image 16, provide an expanded product description 14, improve or customize an incomplete or low quality expanded product description 14a, or the like or a combination or sub-combination thereof.

Such an invitation may be made by an interface module 96 in any suitable manner. For example, when appropriate (e.g., when an interface module 96 determines that certain product data 10 could be improved), an interface module 96 may present one or more buttons 104 or the like to a customer. In selected embodiments, one or more such buttons 104 may be superimposed over an image of a receipt 62 (e.g., over a virtual representation or layout that substantially matches a comparable paper receipt) as it is displayed on a computing device of a corresponding customer. Alternatively, one or more buttons 104 may be presented or displayed in other views (e.g., an itemized view 102 of a receipt data 60), pages, menus, or the like that may be reached or accessed via the application, computing device, or the like.

In selected embodiments, each such button 104 may be positioned proximate the product to which it pertains. For example, if a particular product in an itemized list 102 or view 102 lacks a product image 16, an “upload image” button 104a, “take photo” button 104a, or the like may be located in or near the location where such a product image 16 would have been displayed. Similarly, if a particular product in an itemized list 102 or view 102 corresponds to an incomplete or low quality expanded product description 14a, an “improve description” button 104b, “customize description” button 104b, or the like may be located near the listing of the particular product.

In certain embodiments, an invitation may be extended in the context of some motivation. The purpose of the motivation may be to increase the likelihood that a customer will fully accept an invitation to improve product data 10. In selected embodiments, such motivation may be identified or suggested within an invitation (e.g., “upload image and save $$”). Alternatively, or in addition thereto, the motivation may be identified or explained once a customer has acted on an invitation (e.g., appropriately selected one or more buttons 104).

Should one or more customers act on an invitation presented by an interface module 96 (e.g., select a particular button 104 or the like), the interface module 96 may walk the one or more customers through a corresponding process (e.g., a process enabling the upload of a photograph, descriptive text, edited text, or the like). Such a process may include educating one or more customers as to what constitutes a desirable product image 16 (e.g., a perspective view against a white background), what constitutes a proper expanded product description 14, or the like. It may also include informing one or more customers what benefits (e.g., privileges, rewards, reward points, discounts, coupons, gift cards, cash payments, or the like) may be earned by submitting improved product data 10 or improved product data 10 that is later put into widespread use.

Via an appropriate process, an interface module 96 may receive, from one or more customers, improved product data 10 (e.g., product images 16, improved product images 16, expanded product descriptions 14, improved or edited expanded product descriptions 14, or the like). Thus, an interface module 96 may receive from each such customer at least one second product description (e.g., in text or image format) comprising an improvement over a first product description (e.g., a previously stored or utilized description) of a corresponding product.

An output module 98 may support or enable the passing and/or presenting of product data 10 to one or more customers. For example, an output module 98 may support or enable the presenting of one or more product descriptions in text or image format to one or more customers. This may be accomplished in any suitable manner. For example, in selected embodiments, an output module 98 may disseminate updated or improved product data 10 to one or more POS systems 22.

The various functions or modules of a description-improvement module 90 may be enacted or implemented by any suitable system or component thereof. For example, in selected embodiments, one or more functions or modules of a description-improvement module 90 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

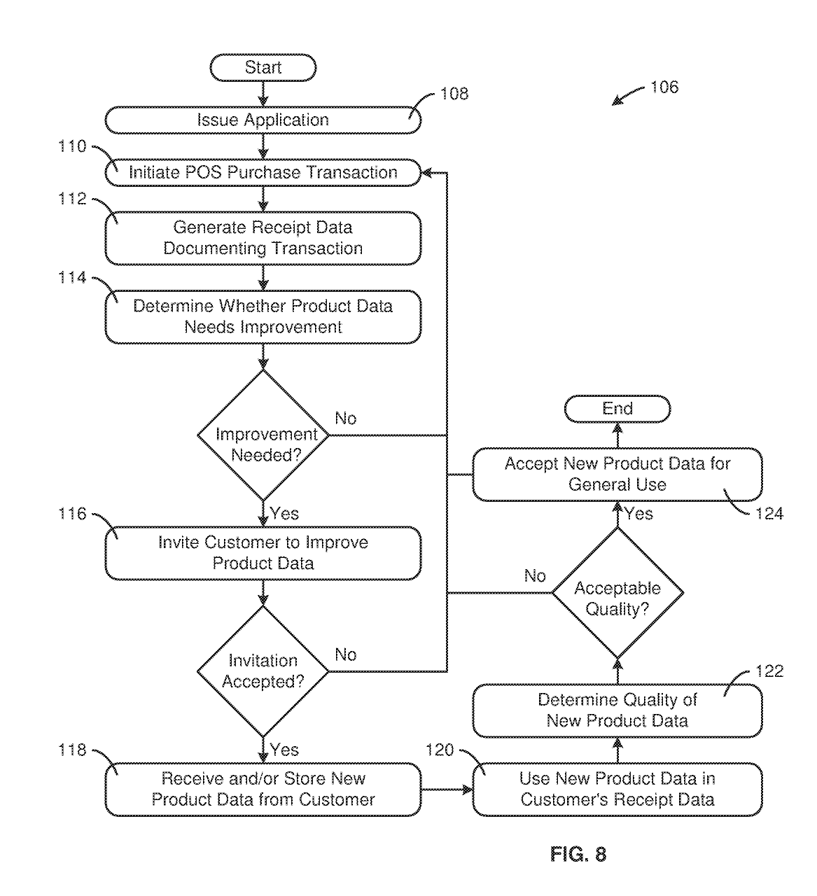

Referring to FIG. 8, one method 106 in accordance with the present invention may begin when an appropriate application (e.g., a retailer's mobile application, an electronic receipts application, browser, or the like or a combination or sub-combination thereof) is issued 108 and installed on a computing device of a customer. In selected embodiments, a computer system may then enroll the customer in an electronic receipts program. In certain embodiments, this enrollment may result in the computing device (or an application installed thereon) being linked to or associated with certain identification information within the records of a computer system.

In other embodiments, the enrollment may be independent of any specific computing device. For example, in selected embodiments, enrollment may comprise the generation of an account. The customer may then access the account (e.g., “log into” the account) using a computing device. Accordingly, a customer may access the account via an appropriate application (e.g., browser) running on any one of several computing devices. Moreover, by “logging out” of an account, the corresponding computing device may be separated from the account.

So prepared, a customer may then enter a “brick-and-mortar” business location (e.g., enter a brick-and-mortar retail store with his or her computing device), select one or more items for purchase, and approach a POS system 22. At the POS system 22, a POS transaction (e.g., a purchase of one or more products) may be initiated 110.

During the transaction, a computer system may receive identification information. For example, a POS system 22 may scan a membership card, club card, loyalty card, identification card, credit card, debit card, finger print, or the like. From the scan, identification information (e.g., a unique identification number, membership number, or the like) may be obtained. Alternatively, while a cashier is processing a transaction, a customer may be prompted via a card reader 30b, customer-facing display 32a, or the like to enter (e.g., type in using the card reader 32b) an identification number (e.g., a mobile telephone number).

Identification information may be passed from a POS system 22 to one or more other computers (e.g., servers 38, 48) within a computer system. The identification information may link a customer and a corresponding transaction to one or more records stored within a computer system. In selected embodiments, such records may contain the information necessary to identify and communicate with a computing device or account of the corresponding customer. Accordingly, a computer system may deliver receipt data 60 documenting the transaction to an appropriate computing device or account.

At some point (e.g., during a transaction or sometime thereafter), a computer system may generate 112 or collect 112 receipt data 60 documenting the transaction. This generating 112 or collecting 112 may include identifying product data 10. For example, generating 112 or collecting 112 may include identifying, by the computer system, one or more first or initial product descriptions (e.g., initial or currently stored product data 10 such as abbreviated product descriptions 12, expanded product descriptions 14, product images 16, or the like) describing instances of one or more product being purchased as part of the transaction.

In selected embodiments, a computer system may determine 114 whether any such first product descriptions need improvement (e.g., are missing, of low quality, of unknown quality, or the like). If it is determined that no product data 10 corresponding to the transaction needs improvement, then a corresponding method 106 may end or continue in the form of waiting for the next transaction. Conversely, if it is determined that one or more pieces of the product data 10 need to be improved, then a computer system may invite 116 the customer to improve the product data 10. For example, one or more buttons 104 may be presented, by a computer system via a computing device of the customer, in conjunction with one or more first product descriptions.

If no such invitation is accepted, then a corresponding method 106 may end or continue in the form of waiting for the next transaction. Conversely, if any such invitation is accepted (e.g., an appropriate button 104 is selected and a corresponding submission process is completed), a computer system may receive 118 and/or store 118 one or more second, updated, new, or improved product descriptions (e.g., improved product data 10 such as new or improved expanded product descriptions 14, new or improved product images 16, or the like or a combination thereof) provided by the customer.

Improvements found in one or more second product descriptions may take any suitable form. For example, a customer may improve a first product description by taking and uploading a photograph of a product to provide a computer system with its first image 16 of that product or a second product image 16 that is clearer, more interesting, or the like than a first product image 16 previously stored within the computer system.

In selected embodiments, a second product description may comprise more characters that the first product description. For example, a first product description may include one or more abbreviations. Accordingly, a corresponding second product description may include one or more words expanding upon (e.g., completely spelling out) the one or more abbreviations.

In other embodiments or situations, a second product description may be an expansion or elaboration of a first product description. For example, a first product description (e.g., an expanded product description 14) may comprise the text “ORBIT chewing gum.” Accordingly, a second product description (e.g., an expanded product description 14 of greater quality or informational content) may comprise the text “ORBIT Spearmint Sugarfree Chewing Gum, 6 Count.”

In selected embodiments, once received 118, such new or improved product data 10 may be used 120 in connection with the customer's receipt data 60. For example, if a customer submits an expanded product description 14 in connection with a particular product, that expanded product description 14 may be used 120 by the computer system when referring to that particular product in one or more of the customer's receipts 62 (e.g., in one or more itemized views 102 of the customer's receipts 62). In selected embodiments, this use 120 of the new or improved product data 10 may extend to one or more of the customer's previous transactions, one or more of the customer's subsequent transactions, one or more of the customer's future transactions, or the like or a combination or sub-combination thereof.

Alternatively, or in addition to such use 120, once received 118, such new or improved product data 10 may be vetted to determine 122 whether it is of sufficiently quality to merit use with other customers. In selected embodiments, such determining 122 may include modifying the new or improved product data 10 to make it of sufficient quality to merit use with other customers. For example, a computer system may filter out one or more words, correct one or more misspellings, white out one or more backgrounds, or the like or a combination or sub-combination thereof.

If it is determined that the new or improved product data 10 is unacceptable and/or cannot be modified to be acceptable, then a corresponding method 106 may end or continue in the form of waiting for the next transaction. Conversely, if the new or improved product data 10 is determined 122 to be of sufficient quality (or is modified to be such), then the new or improved product data 10 may be accepted 124 for more wide spread use (e.g., use with one or more customers other than the customer who submitted the new or improved product data 10 or the select customers that may have assisted in the vetting of the improved product data 10). Thus, the new or improved product data 10 may be disseminated within the receipt data 60 of one or more previous transactions, one or more subsequent transactions, or the like or a combination thereof.

The flowchart in FIG. 8 illustrates the architecture, functionality, and operation of possible implementations of systems, methods, and computer program products according to certain embodiments of the present invention. In this regard, each block in the flowchart may represent a module, segment, or portion of code, which comprises one or more executable instructions for implementing the specified logical function(s). It will also be noted that each block of the flowchart illustration, and combinations of blocks in the flowchart illustration, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

For example, in selected embodiments, the step of determining 114 whether product data 10 corresponding to a particular transaction needs improvement may be omitted. Accordingly, an invitation to improve product data 10 may be extended for substantially all products forming part of the corresponding transaction. Similarly, in certain embodiments, the step of using 120 new or improved product data 10 within the corresponding customer's receipt data 60 may be omitted or occur after a determination 122 of quality has been made or a particular threshold of quality has been met (e.g., after all potentially offensive words or phrases have been removed). Accordingly, in selected embodiments, all new or improved product data 10 may be subject to at least some quality control.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer-implemented method for obtaining improved product descriptions, the method comprising:
completing, by a point-of-sale system forming part of a computer system, a sale of a product to a first human customer;
sending, by the computer system as part of the completing, a first product description to a first computing device of the first human customer, the first product description describing the product;
inviting, by the computer system, the first human customer to improve the first product description;
receiving, by the computer system from the first human customer via the first computing device, a second product description comprising an improved description of the product; and
storing, by the computer system, the second product description.

2. The method of claim 1, wherein the point-of-sale system is contained within a brick-and-mortar store corresponding to a retailer.

3. The method of claim 2, wherein the completing comprises receiving the first human customer within the brick-and-mortar store.

4. The method of claim 3, wherein the computer system comprises a first instance of an application installed on the first computing device.

5. The method of claim 4, wherein the sending comprises sending, by the computer system, first receipt data documenting the sale to the first instance of the application.

6. The method of claim 5, wherein the first receipt data includes the first product description.

7. The method of claim 6, wherein the inviting comprises displaying, by the first instance of the application on the first computing device in proximity to the first product description, an option to improve upon the first product description.

8. The method of claim 6, wherein the second product description comprises more characters than the first product description.

9. The method of claim 8, wherein:
the first product description comprises at least one abbreviation; and
the second product description comprises at least one complete word expanding upon the least one abbreviation.

10. The method of claim 6, wherein the second product description comprises a photograph of the product taken by the first human customer.

11. The method of claim 6, further comprising presenting, by the first instance of the application, the second product description to the first human customer.

12. The method of claim 6, further comprising identifying, by the computer system after the storing, a another instance of the product as being purchased by a second human customer.

13. The method of claim 12, further comprising supplying, by the computer system via a second instance of the application installed on a second computing device corresponding to the second human customer, second receipt data.

14. The method of claim 13, wherein the supplying further comprises supplying, as part of the second receipt data, the second product description.

15. The method of claim 11, further comprising conducting, by the computer system prior to the supplying, a quality review of the second product description.

16. The method of claim 15, wherein the first computing device comprises a mobile telephone.

17. A computer-implemented method for obtaining improved product descriptions, the method comprising:
completing, by a point-of-sale system forming part of a computer system, a sale of a product to a first human customer;
identifying, by the computer system, a first product description describing the product;
delivering, by the computer system to the first human customer via a first instance of an application running on a first computing device of the first human customer, first receipt data documenting the sale, the first receipt data comprising the first product description;
inviting, by the computer system, the first human customer to improve the first product description;
receiving, by the computer system from the first human customer via the first computing device, a second product description comprising an improved description of the the product; and
storing, by the computer system, the second product description.

18. The method of claim 17, further comprising
identifying, by the computer system after the storing, another instance of the product as being purchased by a second human customer; and
supplying, by the computer system to the second human customer via a second instance of the application installed on a second computing device corresponding to the second human customer, second receipt data comprising the second product description.

19. The method of claim 18, further comprising conducting, by the computer system prior to the supplying, a quality review of the second product description.

20. A computer system comprising:
one or more processors;
one or more memory devices operably connected to the one or more processors; and
the one or more memory devices collectively storing
a data store storing a plurality of product descriptions relating to a plurality of products,
an output module programmed to include one or more first product descriptions of the plurality of product descriptions within one or more receipts delivered to one or more human customers,
an interface module programmed to invite the one or more human customers to improve the one or more first product descriptions, and
the interface module further programmed to receive from the one or more human customers one or more second product descriptions, each of the one or more second product descriptions comprising an improvement over a corresponding description of the one or more first product descriptions.
